(19) United States
(12) Patent Application Publication
(10) Pub. No.: US 2024/0002639 A1
(43) Pub. Date: Jan. 4, 2024

(54) SUSTAINABLE APPROACH TO IMPROVE THE TOUGHNESS OF THERMOSET MATERIALS AND COMPOSITES

(71) Applicant: SAUDI ARABIAN OIL COMPANY, Dhahran (SA)

(72) Inventors: Yassine Malajati, Beachwood, OH (US); Aziz Fihri, Paris (FR); Remi Mahfouz, Dhahran (SA)

(73) Assignee: SAUDI ARABIAN OIL COMPANY, Dhahran (SA)

(21) Appl. No.: 17/855,421

(22) Filed: Jun. 30, 2022

(51) Int. Cl. C08K 9/06; C09C 3/12; C09C 1/30; C08G 59/24; C08G 59/50

(52) U.S. Cl. CPC C08K 9/06; C09C 3/12; C09C 1/3081; C08G 59/245; C08G 59/5026; C01P 2004/64; C01P 2004/62; C01P 2004/04

(57) ABSTRACT

A functionalized inorganic filler includes an inorganic particle that including a surface functionality that is at least one reactive cyclic carbonate group linked to a surface of the inorganic particle. A method of making a functionalized inorganic filler includes providing inorganic particles with at least one reactive compound to form a reactive mixture, agitating the reactive mixture to form a modified inorganic particle having a reactive surface functionality, and reacting the modified inorganic particle with a cyclizing compound to form the functionalized inorganic filler. A polymer composite includes an epoxy-based polymer matrix including an amine curing agent and a functionalized inorganic filler.

### BACKGROUND

Epoxy resins are an important class of thermosetting polymers, containing more than one epoxy group capable of reacting with suitable curing agents to form highly crosslinked/three-dimensional networks after curing. Other constituents such as catalysts, fillers, or diluents may be included in the formulation to modify certain properties of the thermoset material. Because of their unique structures, epoxies exhibit superior properties including high mechanical strength, high adhesive strength, low shrinkage, good chemical resistance, and good electrical insulation properties, among others. These properties enable epoxy resins to have a widespread use in different applications such as coatings, adhesives, composites, etc., and for different sectors including building and construction, automotive, aerospace, electronics, renewable energy (e.g. wind turbines, rotor blades, etc.).

However, the highly crosslinked nature of epoxies causes them to be relatively brittle and stiff, with poor resistance to crack initiation and growth and hence low toughness and impact resistance. This inherent brittleness and low toughness are indeed one of the major drawbacks of epoxy resins limiting their use in a number of applications, particularly structural applications. In epoxy-based composites such as carbon fiber- or glass fiber reinforced plastics (CFRP and GFRP), minor impacts, especially transverse impacts, can result in very small defects and damages known as barely visible damages (BVD), that may lead to debonding and delamination issues. If not properly addressed, these issues can cause serious safety concerns and may lead to dramatic failures, especially in safety-sensitive industries such as aeronautics, defense, oil and gas, etc.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a functionalized inorganic filler including an inorganic particle that includes a surface functionality, wherein the surface functionality is at least one reactive cyclic carbonate group linked to a surface of the inorganic particle.

In another aspect, embodiments disclosed here relate to a method of making a functionalized inorganic filler including providing inorganic particles with at least one reactive compound to form a reactive mixture, agitating the reactive mixture to form a modified inorganic particle having a reactive surface functionality, and reacting the modified inorganic particle with a cyclizing compound to form the functionalized inorganic filler.

In yet another aspect, embodiments herein relate to a polymer composite including an epoxy-based polymer matrix, wherein the epoxy-based polymer matrix includes an amine curing agent and a functionalized inorganic filler.

Other aspects and advantages of the claimed subject matter will be apparent from the following description and the appended claims.

### BRIEF DESCRIPTION OF DRAWINGS

FIG. 1 is a block flow diagram outlining a method of making a functionalized inorganic filler in accordance with one or more embodiments of the present disclosure.

FIG. 2A is a reaction scheme for making the modified inorganic filler in accordance with one or more embodiments of the present disclosure.

FIG. 2B is a reaction scheme for making the functionalized inorganic filler in accordance with one or more embodiments of the present disclosure.

FIG. 2C is a reaction scheme for making a mixture of the functionalized inorganic filler and a cyclic carbonate epoxy resin in accordance with one or more embodiments of the present disclosure.

FIG. 3 is a schematic of at least one covalent linkage of a cured polymer composite in accordance one or more embodiments of the present disclosure

FIG. 4 is a method for forming the polymer composites of one or more embodiments of the present disclosure.

FIG. 5 is a transmission electron microscopy image of a modified inorganic filler in accordance with one or more embodiments of the present disclosure

### DETAILED DESCRIPTION

The present disclosure generally relates to toughening agents and rigid inorganic fillers for epoxy resins. Such fillers and toughening agents may enhance the toughness of polymer materials, such as epoxy-based polymers, without adversely affecting their thermo-mechanical properties. The effectiveness of these particulate fillers may be a result of a number of parameters, including their shape, concentration, size, and composition, among others. In one or more embodiments of the present disclosure, the particle size of the fillers is particularly important. For example, relatively large particles may considerably increase the viscosity of epoxy resins, causing processability issues inevitably limiting the use of such composites in certain processes and applications. Thus, relatively small fillers, such as fillers of the nanoscale, may be used for enhanced processability.

Embodiments of the present disclosure generally relate to a functionalized inorganic filler composition, a method of forming the functionalized inorganic filler from an intermediate (or “modified”) inorganic filler, and a method of forming polymer composites with the functionalized inorganic filler. In one or more embodiments, the functionalized inorganic filler may include a surface functionalization of the inorganic material. The polymer composites of one or more embodiments may have enhanced toughness and good processability.

### Functionalized Inorganic Filler Composition

In one or more embodiments, the functionalized inorganic filler may include an inorganic material. The inorganic material may be a plurality of inorganic particles. The inorganic particles may be selected from the group consisting of silica, titanium dioxide, zinc oxide, zirconium dioxide, and combinations thereof. In one or more particular embodiments, the inorganic particle may be silica.

The plurality of inorganic particles (or “inorganic particles”) of one or more embodiments may include particles of different shapes, meaning they may be non-uniform shapes. In such embodiments, the inorganic particles may be core-shell particles, hollow particles, and/or solid particles. In one or more particular embodiments, the plurality of inorganic particles may have a defined shape. In such embodiments, the defined shape of the inorganic particles may include shapes selected from the group consisting of spheres, tubes, lamellas, rods, dendrites, bristle-like, fibers, and combinations thereof. The inorganic particles according to one or more embodiments of the present disclosure may have a spherical shape.

In one or more embodiments, the inorganic particles may have an average size. As described herein, the average particle size refers to the average diameter of the particles as measured by electron microscopy such as transmission electron microscopy (TEM), scanning electron microscopy (SEM), or dynamic light scattering (DLS). In such embodiments, the average diameter of the inorganic particles may be in a range of 15 to 500 nm (nanometers). The average diameter of the inorganic particles may have a lower limit of one of 15, 20, 25, 50, 75 and 100 nm and an upper limit of one of 100, 200, 300, 400, and 500 nm, where any lower limit may be paired with any mathematically upper limit.

As noted above, the functionalized inorganic filler may include inorganic particles including a particular surface functionality. The surface functionality of the inorganic particles of one or more embodiments may include at least one reactive compound chemically linked to the surface of the inorganic particles. In one or more embodiments, the functionalized inorganic filler may be a product of a reaction between a modified (or intermediate) inorganic filler and at least one molecule of a cyclizing agent. The cyclizing agent may be any compound capable of reacting with a reactive terminal group of the modified inorganic filler to form at least one cyclic structure. In such embodiments, the cyclizing agent may be carbon dioxide (CO₂) to produce at least one cyclic carbonate functionality linked to the reactive compound included on the surface of the inorganic particles.

As one of ordinary skill of the art may appreciate, the reactive compound may include any chemical structure (or “linker group”) that may form a chemical linkage to the surface of the inorganic particles. In one or more embodiments, the reactive compound of the surface functionality may be a compound with a reactive terminal group and a linker group. In such embodiments, the linker group may form a chemical bond with a surface-active group on a surface of the inorganic particle. The linker group may be a silane group, such as a triether silane group as described below. The reactive terminal group may be a cyclic carbonate connected to the linker group via a hydrocarbon group, an epoxide connected to the linker group via a hydrocarbon group, or combinations thereof.

As used throughout this disclosure, the term “hydrocarbon group” refers to branched, straight chain, and/or ring-containing hydrocarbon groups, which may be saturated or unsaturated. The hydrocarbon groups may be primary, secondary, and/or tertiary hydrocarbons. In one or more embodiments, the hydrocarbon group may be a substituted hydrocarbon group (as defined above) where at least one hydrogen atom is replaced with a non-hydrogen group that results in a stable compound. Such substituents may be groups selected from, but are not limited to, halo, hydroxyl, alkoxy, oxo, alkanoyl, aryloxy, alkanoyloxy, amino, alkylamino, arylamino, arylalkylamino, disubstituted amines, alkanylamino, aroylamino, aralkanoylamino, substituted alkanoylamino, substituted arylamino, aubstituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide, substituted sulfonamide, nitro, cyano, carboxy, carbamyl, alkoxycarbonyl, aryl, substituted aryl, guanidine, vinyl, acetylene, acrylate, cyanate, epoxide, and heterocyclyl groups, and mixtures thereof.

In one or more embodiments, the reactive compound may be an epoxy silane. In such embodiments, the epoxy silane may be selected from the group consisting of (3-glycidyloxypropyl)trimethoxysilane, (3-glycidyloxypropyl)triethoxysilane, (diethoxy 3-glycidyloxypropyl)methylsilane, and combinations thereof. In one or more particular embodiments, the epoxy-bearing group may be (3-glycidyloxypropyl)trimethoxysilane.

As described below, embodiments of the present disclosure also include methods of make the functionalized inorganic filler, the modified inorganic filler, and combinations thereof.

### Method of Forming a Functionalized Inorganic Filler

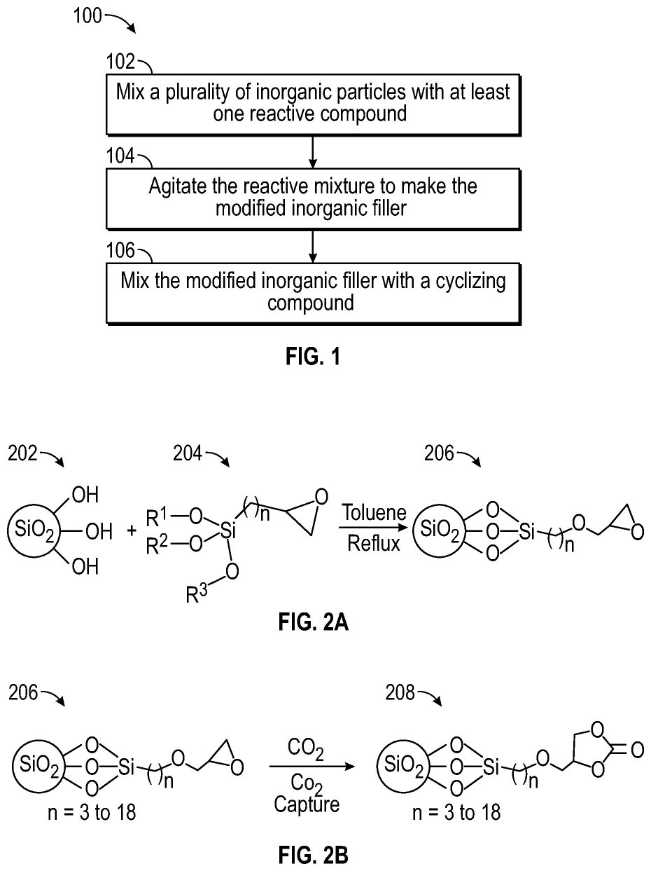

Embodiments of the present disclosure also relate to a method of making the previously described functionalized inorganic filler 100 (FIG. 1). The method includes step 102 of mixing inorganic particles with at least one reactive compound to form a reactive mixture. In such embodiments, the inorganic particles may be prepared via a hydrothermal process or obtained commercially. Any suitable hydrothermal method known in the art may be used to prepare the inorganic particles. The method further includes step 104, which includes agitating the reactive mixture to form a modified inorganic filler. The inorganic particles, the reactive compound, and the modified inorganic filler may be as described above. Step 106 includes mixing the modified inorganic filler with a cyclizing compound to form the functionalized inorganic filler.

In one or more embodiments, making the modified inorganic filler may include functionalizing a surface of the inorganic particles. The particles are functionalized in step 102. Step 102 includes mixing the inorganic particles with at least one reactive compound to form the modified inorganic filler. In such embodiments, the inorganic particles may be dispersed in a solvent for a period of time prior to mixing the at least one reactive compound. The inorganic particles may be added to the solvent in an amount of 5 to 25 wt % (weight percent) based on the total weight of the solvent. For example, in one or more embodiments, the inorganic particles may be included in an amount ranging from a lower limit of one of 5, 8, 10, 12, and 15 wt % to an upper limit of one of 15, 18, 20, 22, and 25 wt %, where any lower limit may be paired with any mathematically compatible upper limit. The inorganic particles may be dispersed using a method known to those skilled in the art, such as sonication, agitation, mechanical mixing, and combinations thereof. The solvent may be an organic solvent. The organic solvent may be a carbon-based solvent, such as a non-polar solvent, a polar solvent, and combinations thereof, that is capable of dissolving and/or dispersing at least one other substance. In one or more particular embodiments, the organic solvent may be a hydrocarbon solvent, such as toluene.

In one or more embodiments, the inorganic particles may be functionalized by chemically linking a reactive compound described above to the surface of the inorganic particle. This may be achieved by mixing the reactive compound with the dispersed inorganic particles. The reactive compounds may be present in the mixture in an amount in a range from about 5 to 25 wt % based on the amount of inorganic particles. For example, in one or more embodiments, the reactive compounds may be present in the mixture in an amount ranging from a lower limit of one of 5, 8, 10, 12, and 15 wt % ot an upper limit of one of 15, 18, 20, 22 and 25 wt %, where any lower limit may be paired with any mathematically compatible upper limit.

[agitating step] In step 104, the mixture may be agitated via mechanical mixing, blending, or any other agitation method known to those skilled in the art to promote the formation of the modified inorganic filler. In one or more embodiments, the agitation may stimulate the mixture such that a linker group of the reactive compound may chemically link (or form a bond) to a reactive group on the surface of the inorganic particles. In such embodiments, the temperature of the reaction mixture may be elevated or decreased for an amount of time. For example, the reaction mixture may be heated to reflux.

In one or more embodiments, the modified inorganic fillers may be isolated prior to forming the functionalized inorganic fillers. The modified inorganic fillers may be isolated as solid particles using methods known to one of ordinary skill in the art. For example, the modified inorganic fillers may be isolated using methods including washing, filtering, centrifuging, decanting, and combinations thereof to remove any unreacted reactive compound. The isolated modified inorganic fillers may be further dried such that residual solvent is removed via heating or vacuum drying for an amount of time.

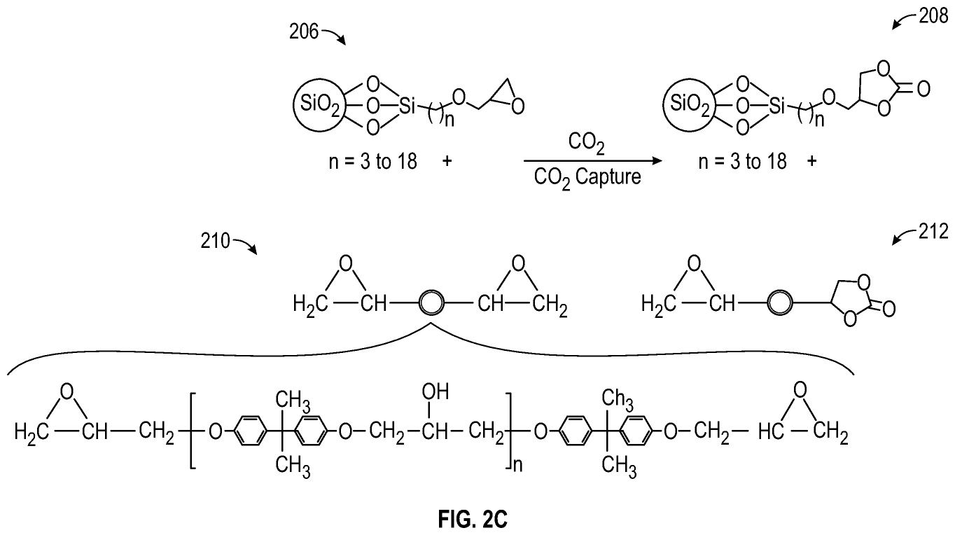

A reaction scheme in accordance with the previously described method of making the modified inorganic filler is presented in FIG. 2A. In this regard, silica particles 202 with hydroxy groups on the surface of the particles may react with an epoxy silane reactive compound 204, and in particular (3-glycidyloxypropyl)trimethoxysilane. Silica particles 202 may be dispersed in dry toluene via stirring at room temperature for a period of time, such as 30 minutes. Then (3-glycidyloxypropyl)trimethoxysilane may be added dropwise. A modified inorganic filler 206 may be obtained after agitating the reaction mixture in toluene for a period of time. The modified inorganic filler 206 may then be isolated, washed, and dried using methods as known to those skilled in the art.

Referring back to FIG. 1, the functionalized inorganic particle may be synthesized by mixing the isolated modified inorganic filler with a cyclizing compound in step 106. As such, FIG. 2B is a schematic that depicts the transformation of the modified inorganic filler 206 to provide functionalized inorganic particles 208. In such embodiments, the cyclizing compound may be a compound as described above, such as CO₂. The modified inorganic filler may be dispersed according to methods described above and then mixed with the cyclizing compound.

In some embodiments, as depicted in FIG. 2C, the modified inorganic filler 206 and an epoxy resin, such as bisphenol A diglycydyl ether (DGEBA) 210, may be exposed to CO₂ to form a mixture of functionalized inorganic particles 208 and an epoxy resin cyclic carbonate 212. In particular, the modified inorganic filler and the epoxy resin may be reacted in a closed system such as an autoclave reactor pressurized with CO₂ gas. The reaction may be performed in a closed system under a pressure ranging from 150 to 200 psi (pounds per square inch). For example, the pressure exerted on the reaction with CO₂ gas may range from a lower limit of one of 150, 155, 160, 165, and 170 psi to 180, 185, 190, 195, and 200 psi, where any lower limit may be paired with any mathematically compatible upper limit.

The modified inorganic filler and the epoxy resin may be exposed to pressurized CO₂ gas at an elevated temperature for a sufficient amount of time to effectively form an epoxy resin cyclic carbonate. For example, in one or more embodiments, the reaction to form an epoxy resin cyclic carbonate is carried out at an elevated temperature ranging from 80 to 150° C. for 10 to 20 hours. The elevated temperature may range from a lower limit of one of 80, 90, 100, 110, and 120° C. to an upper limit of 110, 120, 130, 140, and 150° C., where any lower limit may be paired with any mathematically compatible upper limit. The reaction may be carried out for a sufficient amount of time ranging from a lower limit of one of 10, 11, 12, 13, 14, and 15 hours to an upper limit of one of 15, 16, 17, 18, 19, and 20 hours, where any lower limit may be paired with any mathematically compatible upper limit.

In one or more embodiments, a catalyst may be included in the reaction to form an epoxy resin cyclic carbonate. Suitable catalysts include, but are not limited to tetrabutylammonium bromide (TBAB), tetrabutylammonium fluoride (TBAF), and combinations thereof.

In some embodiments, epoxy-based particles are suspended in a solvent and then exposed to CO₂ gas. The solvent may be a nonpolar aromatic solvent such as toluene. In embodiments in which the epoxy-based particles are suspended in a solvent, the epoxy-based particles may be present in a concentration ranging from 5 to 25 wt %. For example, the epoxy-based particle may be suspended in a solvent in a concentration ranging from a lower limit of one of 5, 8, 10, 12, and 15 wt % to an upper limit of one of 15, 18, 20, 22, and 25 wt %, where any lower limit may be paired with any mathematically compatible upper limit.

Epoxy resin cyclic carbonates may be characterized according to various analytical techniques known in the art. For example, liquid and solid nuclear magnetic resonance (NMR), Fourier-transform infrared spectroscopy (FTIR), among others, may be used to characterize the prepared epoxy resin cyclic carbonates.

The functionalized inorganic particle may be made by the methods described above in the order as described. However, the same particle functionalization may be achieved through a different order of operations. In another example, embodiments of the present disclosure may include optionally chemically modifying the reactive compound described above with the cyclizing compound to form a cyclic-carbonate reactive compound prior to chemically linking the reactive compound to the surface groups of the inorganic particles. In such embodiments, an epoxy group of the reactive compound may be chemically modified via reaction with carbon dioxide as described above. The cyclic-carbonate reactive compound may then be used to functionalize the surface of the inorganic particles using the methods described above.

In one or more particular embodiments, the modified inorganic filler, the functionalized inorganic filler, the reactive compound, and combinations thereof may be mixed with at least one epoxy resin to form an epoxy resin mixture prior to the step of mixing the cyclizing agent as described above. In such embodiments, the epoxy resin of the epoxy resin mixture may include epoxy resins described below. In one or more particular embodiments, the epoxy resin may be selected from the group consisting of diglycidyl ether of bisphenol A, diglycidyl ether of bisphenol F, epoxy phenol novolac resins, and combinations thereof.

### Composition of Polymer Composite

Polymer composites of one or more embodiments may include at least one functionalized inorganic filler, at least one epoxy resin, and at least one curing agent. As used in this disclosure, the term “polymer composites” refers to a combination of polymeric materials, fillers, curing agents, and optional additives. The term “polymeric materials” refers to existing polymers, constituents that react to form polymers (such as monomers and oligomers), and combinations thereof. The constituents that react to form polymers may include but are not limited to epoxy resins, fillers, and curing agents. The fillers may include the functionalized inorganic fillers of one or more embodiments described above.

In one or more embodiments, the polymer composite may be an epoxy resin-based composite. The epoxy resins may be mixed in an amount of the epoxy resin sufficient to form a cured epoxy composition. For example, the epoxy resin system may include from about 50 wt. % (weight percent) to about 98 wt. % of epoxy resin based on the total weight of the polymer composite before curing. The epoxy resin may have a lower limit of one of 50, 55, 60, 65, and 70 wt. %, and an upper limit of one of 75, 80, 85, 90, 95, and 98 wt. %, of the polymer composite, where any lower limit may be paired with any upper limit.

Examples of suitable epoxy resins include, but are not limited to, bisphenol-A-based epoxy resins, bisphenol-F-based epoxy resins, aliphatic epoxy resins, aromatic epoxy resins, Novalac resins, and combinations thereof. Aliphatic and aromatic epoxy resins may include glycidyl ethers and diglycidyl ethers. Glycidyl ethers may include alkyl glycidyl ethers, aromatic glycidyl ethers, or both. Glycidyl ethers have a chemical structure as shown in Formula (I):

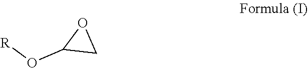

where R may be a linear, branched, cyclic, or aromatic hydrocarbon having from 4 to 24 carbon atoms. The hydrocarbon group may have a lower limit of one of 4, 6, 8, 10, and 12 carbon atoms, and an upper limit of one of 12, 14, 16, 18, 20, 22, and 24 carbon atoms, where any lower limit may be paired with any upper limit. In some embodiments, R may include one or more substituted or unsubstituted aromatic rings. In some embodiments, the epoxy resin may include C₁₂-C₁₄ alkyl glycidyl ethers, butyl glycidyl ether, 2,3-epoxypropyl-o-tolyl ether, or combinations of these. Diglycidyl ethers have chemical structure as shown in Formula (II):

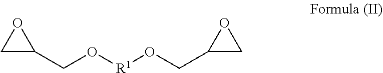

where R¹ may be a linear, branched, cyclic, or aromatic hydrocarbyl having from 4 to 24 carbon atoms. The R¹ group may have a lower limit of one of 4, 6, 8, 10, and 12 carbon atoms, and an upper limit of one of 12, 14, 16, 18, 20, 22, and 24 carbon atoms, where any lower limit may be paired with any upper limit. In one or more embodiments, R¹ may include one or more substituted or unsubstituted aromatic rings. In one or more embodiments, R¹ may be an alkyl group or cycloalkyl group. For example, the epoxy resin may include 1,6-hexanediol diglycidyl ether, which has chemical structure as shown in Formula (III):

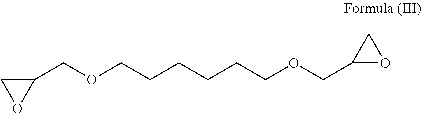 [SMILES: C(CCCOCC1CO1)CCOCC1CO1]

Non-limiting examples of the epoxy resin of one or more embodiments may be selected from the group consisting of diglycidyl ether of bisphenol A, diglycidyl ether of bisphenol F, epoxy phenol novolac resins, and combinations thereof. In one or more particular embodiments, the epoxy resin may be bisphenol-A-diglycidyl ether (DGEBA), as shown in Formula (IV)

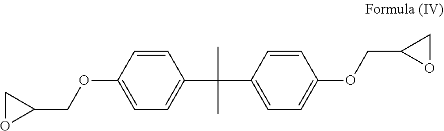 [SMILES: CC(C)(c1ccc(OCC2CO2)cc1)c1ccc(OCC2CO2)cc1]

[filler amount] The functionalized inorganic filler may be included in the polymer composite in an amount ranging from 0.1 to 30 wt. % based on the amount of epoxy resin. The functionalized inorganic filler may be included in an amount having a lower limit of one of 0.1, 0.25, 0.5, 1.0, 2.0, 5.0, 10, and 15 wt. % and an upper limit of one of 10, 12.5, 15, 20, 25, 27.5 and 30 wt. %, where any lower limit may be paired with any mathematically compatible upper limit.

The curing agent may be an amine curing agent. The curing agent may include at least one amine group. The term “amine” as used refers to primary, secondary, and tertiary amines having, for example, the formula N(group)₃, where each ‘group’ can independently be H or non-H, such as alkyl and aryl. Amines include, but are not limited to, R—NH₂, for example, alkylamines, arylamines, alkylarylamines; R₂NH, where each R is independently selected, such as dialkylamines, diarylamines, arylalkylamines, and heterocyclylamines; and R₃N, where each R is independently selected, such as trialkylamines, dialkylarylamines, alkyldiarylamines, and triarylamines. The term “amine” also includes ammonium ions as used.

Curing agents with amine functional groups may include, but are not limited to, an amine, polyamine, amine adduct, polyamine adduct, alkanolamine, phenalkamines, or a combinations of these. Examples of amine or polyamine curing agents may include, but are not limited to, aliphatic amines; cycloaliphatic amines; modified cycloaliphatic amines, such as cycloaliphatic amines modified by polyacrylic acid; aliphatic polyamines; cycloaliphatic polyamines; modified polyamines, such as polyamines modified by polyacrylic acid; or amine adducts, such as cycloaliphatic amine adducts and polyamine adducts.

In one or more particular embodiments, a diamine curing agent may be used. Non-limiting examples of diamine curing agents are aliphatic amines, such as triethylenetetramine (TETA, Formula V) or diethylenetriamine (DETA, Formula VI), aromatic amines, such as m-phenylenediamine (MDP, Formula VII) or methylenedianiline (MDA, Formula VIII), and cycloaliphatic amines, such as isophorone diamine (IPDA, Formula IX). Such diamines may be used alone or in combination.

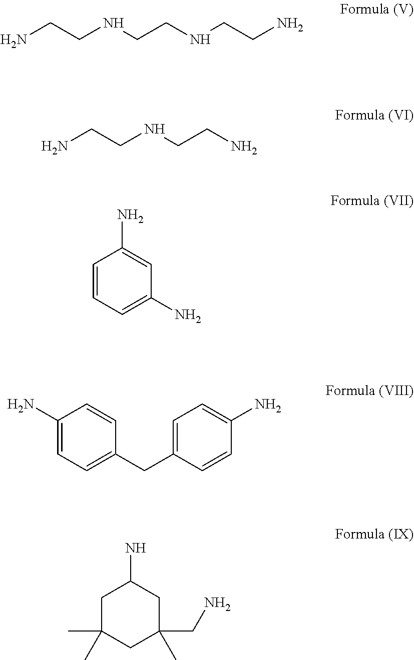

The curing agent may be included in a range of from about 0.5 to 10 wt. % of the curing agent based on the total weight of the polymer composite before curing. The curing agent in the epoxy resin system may have a lower limit of one of 0.5, 1.0, 1.5, 2.0, 2.5, 3.0, 3.5, and 4.0 wt. %, and an upper limit of one of 5.0, 6.0, 7.0, 8.0, 9.0 and 10.0 wt. %, where any lower limit may be paired with any upper limit.

As used throughout this disclosure, the term “cure” or “curing,” when used in the context of the epoxy resins and the polymer composites refers to the process of cross-linking the epoxy resin, which is in a liquid form initially, with a curing agent to form a solid cured epoxy polymer.

[urethane bonds] Polymer composites of one or more embodiments may include at least one cured epoxy polymer network. The at least one cured epoxy polymer network may include a plurality of covalent linkages (or “cross-links”) of at least one functional group of the epoxy resin, the functionalized inorganic filler, the amine curing agent, and combinations thereof. Examples of the plurality of covalently linked functional groups may be derived from epoxide rings, cyclic carbonate rings, amine groups, and combinations thereof.

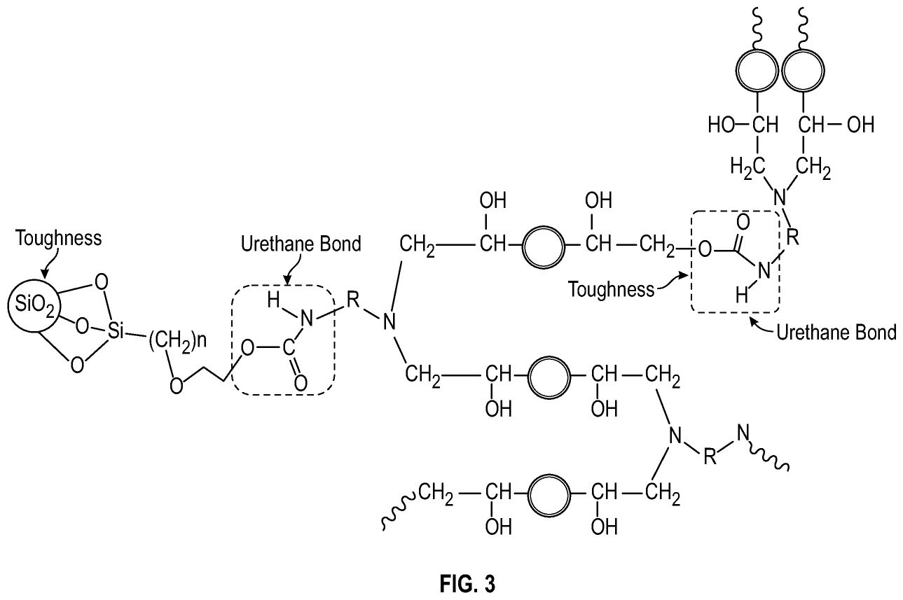

Covalent linkages may include at least one ether linkage, at least one carbonate linkage, at least one urethane linkage, and combinations thereof. The term “urethane linkage” refers to an isocyanate cross-link in the polymer composite. FIG. 3 is a schematic of a cross-linked polymer composite in accordance one or more embodiments of the present disclosure.

Polymer composites of one or more embodiments may have improved toughness and impact resistance compared to epoxy-based polymer composites not including a modified filler disclosed herein. METHOD OF FORMING A POLYMER COMPOSITE

Embodiments of the present disclosure also include making polymer composites using the functionalized fillers of one or more embodiments to increase the toughness and impact resistance of the cured epoxy network by forming urethane linkages.

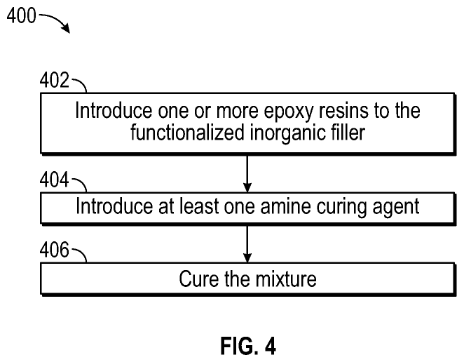

In such embodiments, the method for making the polymer composites 400 as shown in FIG. 4 may include introducing one or more epoxy resins to the functionalized inorganic particle to form a first mixture 402. In such embodiments, the functionalized inorganic particle is as previously described. In step 404, at least one amine curing agent may be introduced to form a second mixture. In step 406, the second mixture may be cured for a period of time to form an epoxy crosslinked network. In such embodiments, the epoxy crosslinked network includes a plurality of urethane linkages.

The polymer composite of one or more embodiments may have a cure time that enables the cross-linking, such as covalently linking, functional groups of the epoxy resin, the functionalized inorganic filler, the modified inorganic filler, and combinations thereof to become a solid in the presence of the amine curing agent. In some embodiments, the curing step may include heating the second mixture for a period of time. In some embodiments, the cure time may be in a range of from about 0.5 to 12 hours. The term “cure time,” when used in the context of the epoxy resins and polymer composites in the present disclosure, refers to a time duration between a first time at which a curing agent is added to the epoxy resins and a second time at which the epoxy resin system has cured to form a solid epoxy.

### Example

Materials

Tetraethyl orthosilicate, (3-glycidyloxypropyl) trimethoxy silane, urea, hexadecyltrimethylammonium bromide, toluene and 1-pentanol were supplied by Sigma-Aldrich. Cyclohexane was supplied by Fisher Scientific. Methods

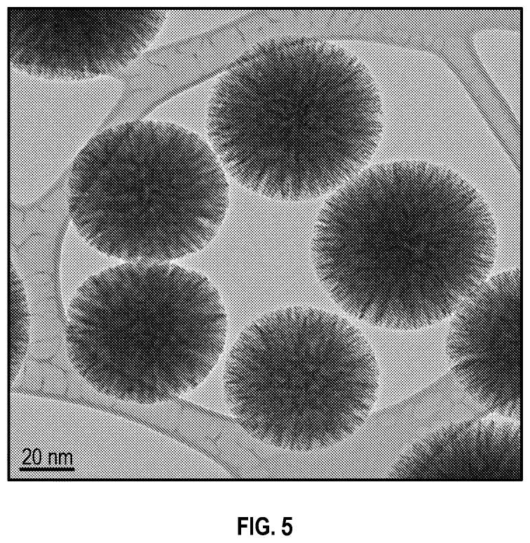

Silica particles were prepared by a hydrothermal process. A solution composed of tetraethoxysilane (20 g), cyclohexane (240 mL) and 1-pentanol (12 mL) was prepared and stirred for 30 minutes. Concurrently, an additional solution including cetyltrimethylammonium bromide (8 g), urea (4.8 g), and deionized water (240 mL) was mixed and stirred for 30 minutes at room temperature. The tetraethoxysilane solution was then added into the cetyltrimethylammonium bromide solution and stirred for 1 hour (h). The solution was then transferred into an autoclave and heated in an oven at 125° C. for 4 to 6 h. The autoclave was then gradually cooled, and the silica particles were collected by repeated centrifugation in deionized water and ethanol. After being dried overnight at room temperature, the synthesized powder was calcined under continuous air flow at 550° C. for 4 h yielding the silica particles as a pure white powder. FIG. 5 shows an image of exemplary DFNs under transmission electron microscopy (TEM) prepared via the hydrothermal process.

In a typical synthesis procedure for the modified inorganic filler, 10 g silica particles were dispersed in dry toluene and stirred for 30 min at room temperature. Epoxy silane, specifically (3-glycidyloxypropyl)trimethoxysilane (30 mL) was added dropwise, and the resulting mixture was refluxed for 48 hours. The modified silica particles were then cooled to room temperature. After cooling, the modified silica particles were collected via repeated centrifugation and washed several times with toluene and ethanol to remove any unreacted (3-glycidyloxypropyl)trimethoxysilane. The modified silica particles were then dried at 120° C. for 4 h.

To prepare composite of bisphenol A diglycidyl ether (DGEBA)/Isophorone diamine (IPDA) and 3 wt. % of modified silica, 0.811 g of silica functionalized with cyclic carbonate derivative of 3-glycidoxypropyl trimethoxy silane is added into 21.87 g of DGEBA and degassed under vacuum at room temperature. Then resulting suspension was dispersed in 4.82 g of isophorone diamine. The final mixture is then degassed under vacuum at room temperature and poured into a silicone mold, and left to cure for 24 h at room temperature. After curing, the mixture is post-cured at 80° C. for 4-5 hours.

Embodiments of the present disclosure may provide at least one of the following advantages. Polymer composites described herein may provide enhanced toughness and flame retardancy performance via introduction of inorganic fillers and urethane bonds throughout a polymer matrix. The improvement of such properties in polymer composites may provide opportunity for the polymer composite material use in non-metallic pipelines inside plants as traditional reinforced thermoset resins possess modest toughness and poor fire resistance properties limiting them from such advanced applications and deployment. As such, advantages of the improved properties may qualify polymer composites of one or more embodiments for use in reinforced thermoset resin pipes, building materials, construction coatings, among others.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A functionalized inorganic filler comprising:
an inorganic particle comprising a surface functionality, wherein the surface functionality is at least one reactive cyclic carbonate group linked to a surface of the inorganic particle.

2. The functionalized inorganic filler of claim 1, wherein the at least one reactive cyclic carbonate group linked to the surface of the inorganic particle is formed from a reaction between a modified inorganic particle and carbon dioxide.

3. The functionalized inorganic filler of claim 2, wherein the modified inorganic particle is formed from a reaction between an inorganic particle and a reactive epoxy-bearing group.

4. The functionalized inorganic filler of claim 3, wherein the inorganic particle is selected from the group consisting of a silica particle, a titanium dioxide particle, a zinc oxide particle, a zirconium dioxide particle, and combinations thereof.

5. The functionalized inorganic filler of claim 4, wherein the inorganic particle is silica.

6. The functionalized inorganic filler of claim 4, wherein the inorganic particle has a shape selected from the group consisting of a sphere, a tube, a lamella, a rod, a dendrite, a fiber, and combinations thereof.

7. The functionalized inorganic filler of claim 1, wherein the particle has a diameter in the range of 15 to 500 nm.

8. The functionalized inorganic filler of claim 3, wherein the reactive epoxy-bearing group is an epoxysilane selected from the group consisting of 3-glycidyloxypropyl trimethoxysilane, 3-glycidyloxypropyl triethoxysilane, diethoxy 3-glycidyloxypropyl methylsilane, and combinations thereof.

9. A method of making a functionalized inorganic filler, the method comprising:
providing inorganic particles with at least one reactive compound to form a reactive mixture;
agitating the reactive mixture to form a modified inorganic particle comprising a reactive surface functionality; and
reacting the modified inorganic particle with a cyclizing compound to form the functionalized inorganic filler.

10. The method of claim 9, wherein the agitating further comprises heating the reactive mixture.

11. The method of claim 9, wherein the at least one reactive compound is an epoxy-bearing reactive compound is selected from the group consisting of 3-glycidyloxypropyl trimethoxysilane, 3-glycidyloxypropyl triethoxysilane, diethoxy 3-glycidyloxypropyl methylsilane, and combinations thereof.

12. The method of claim 9, wherein the inorganic particles comprise an inorganic material selected from the group consisting of silica, titanium oxide, zinc oxide, zirconium oxide, and combinations thereof.

13. The method of claim 9, wherein the cyclizing compound is carbon dioxide.

14. The method of claim 9, further comprising, prior to providing the inorganic particles with at least one reactive compound, mixing the inorganic particles with at least one epoxy resin to form an epoxy mixture.

15. The method of claim 14, wherein the at least one epoxy resin is selected from the group consisting of diglycidyl ether of bisphenol A, diglycidyl ether of bisphenol F, an epoxy phenol novolac resin, and combinations thereof.

16. A polymer composite comprising:
an epoxy-based polymer matrix, wherein the epoxy-based polymer matrix comprises an amine curing agent; and
a functionalized inorganic filler.

17. The polymer composite of claim 16, wherein the functionalized inorganic filler is present in an amount ranging from 0.1 to 30 wt. % (weight percent) based on an amount of the epoxy-based polymer matrix.

18. A method of making the polymer composite of claim 16, the method comprising:
introducing one or more one or more epoxy resins to a functionalized inorganic particle to form a first mixture, wherein the functionalized inorganic particle comprises a surface functionality, wherein the surface functionality is at least one reactive cyclic carbonate group linked to a surface of the inorganic particle;
introducing one or more amine curing agents to form a second mixture; and
curing the second mixture to form an epoxy crosslinked network, wherein the epoxy crosslinked network comprises a plurality of urethane linkages.

19. The method of making the polymer composite of claim 18, wherein the amine curing agent is selected from the group consisting of triethylenetetramine, diethylenetriamine, m-phenylenediamine, methylenedianiline, isophorone diamine, and combinations thereof.
